(19) United States
(12) Patent Application Publication
(10) Pub. No.: US 2004/0045147 A1
(43) Pub. Date: Mar. 11, 2004

(54) Resilient standoff fastener

(76) Inventors: Kenneth A. Swanstrom, Doylestown, PA (US); Harold D. Ross, Chalfont, PA (US); William P. McDonough, Collegeville, PA (US)

Correspondence Address: Gregory J Gore, Suite 316, 70 West Oakland Avenue, Doylestown, PA, 18901, US

(21) Appl. No.: 10/415,938

(22) PCT Filed: Dec. 4, 2001
(86) PCT No.: PCT/US01/45359

(51) Int. Cl. B23P 19/02

(52) U.S. Cl. 29/235

(57) ABSTRACT

An elongate, elastomeric fastener (13, 19) includes a head (13) and barrel section (19). The fastener may be installed into a hole (12) in a panel (11) by stretching by the elastomeric, elongated portion reducing diameter so that it passes through the hole (12) and fastens by releasing the force on the fastener (13, 19) allowing gripping around the hole (12). In yet a further embodiment, a central push-pin (35) may be used to apply an axial force on the fastener which is required to operate the fastener (13, 19).

Priority based upon provisional application serial No. 60/255,374 filed on Dec. 15, 2000, entitled “RESILIENT STANDOFF FASTENER” is hereby claimed.

### FIELD OF THE INVENTION

This invention relates to a resilient fastener including standoff-type fasteners that assemble two flat panels a spaced distance apart. More specifically, it relates to an elastomeric fastener that provides panel grasping and spacing functions solely by its resilience.

### BACKGROUND OF THE INVENTION AND PRIOR ART

A standoff fastener is an element that attaches two panels a spaced distance apart. The panels are generally attached through some type of clipping mechanism, or clamping by threaded fasteners or screws and generally include two types: those that are machined or formed from metal, and those made from plastic. However, whether the fasteners are metal or plastic, the various types of standoffs presently available pose problems. Problem areas include the use of metal standoffs to separate two printed circuit boards. When a printed circuit board is standing off from a metal chassis, the fastener is usually attached to the chassis using methods such as self-clinching or riveting which require tools. The attachment of threaded fasteners is also time consuming, requires a loose mating component such as a screw, and increases the time required to repair items in the field.

When self-clinching fasteners are used, several other problems can also be encountered. The chassis metal must be ductile, limiting the choice of materials used in the chassis, and removal of these fasteners is a destructive process leaving either the chassis or the fastener unusable after removal. Also, the installation or removal of the fastener requires specific tooling which is relatively expensive, or not readily available in the field. And finally, when the fastener is required to make grounding contact between a printed circuit board and the chassis, metal fasteners must be used but have other disadvantages noted above with regard to mounting circuit boards.

The use of plastic fasteners does not solve many of the problems encountered with metal fasteners. When a plastic standoff utilizes threads, debris can fall into the assembly and the plastic standoffs that do not utilize threads are often not resistant to shock, heat, and vibration. Plastic fasteners that do not require special installation tooling are often damaged upon removal so the fastener becomes unusable for re-assembly. Plastic fasteners are also unable to provide electrical conductivity in the event a grounding contact is needed.

Debris or accidental screw contact on sensitive equipment during the manufacturing process is also a problem. Another disadvantage is that if the threaded hole is stripped, the entire panel becomes useless. Furthermore, the location of the holes in the panels to be separated in the assembly can be critical and the tolerance between the holes of the first panel and second panel can be cumulative causing misalignment of the holes so the panels cannot be assembled.

While there have been many attempts in the art to solve the problems above, none to date have been successful. There is therefore a need in the art of panel fastening systems for a fastener that provides new advantages and solves the problems in the art stated above.

### SUMMARY OF THE INVENTION

The present resilient standoff invention addresses and solves many of the problems with the various types of standoffs mentioned above. This fastener has an elastomeric portion, hereinafter the “tail,” that provides retention of the attached panel by the compressive radial grip of displaced tail material. A base of the fastener, which in some embodiments includes a head and a barrel section, provides a positive stop against the further insertion of the tail into the hole of a panel. The base can also function to positively space two panels apart, providing a standoff function. A third embodiment allows the tail-elongation to occur from the opposite side of the fastener by the use of a push-pin extending through the base. All three embodiments as well as other modifications are independent but will also work in conjunction with each other.

Given a panel with a hole having a diameter less than the relaxed diameter of the tail, the tail can fit into the hole of the panel when the tail is stretched to a reduced diameter. When the stretching force is released, the tail grips the interior surface of the hole as well as the surfaces of the panel around it. This occurs because when the tail is released it attempts to return to its original diameter, however the material of the tail restricted by the panel causes the tail to expand or bulge on either side of the panel. This bulge retains the panel at the location along the tail when the stretching was relaxed. The expansion or bulging is also assisted by the tendency for the tail to return to its free length. To remove the panel, the tail is stretched again until the diameter reduces to an amount sufficient to pass the panel back over the tail.

Although useful as a standoff, the simplest form of the fastener invention is its application to a single panel where the protruding base on one side of the panel may serve a useful function such as a support foot commonly found on household or electronic appliances. In this embodiment, the majority of the tail expansion (i.e. bulge) occurs on the side of the panel opposite the annular underside surface of the fastener base which abuts the panel. In more complex embodiments, the base can also include various other structures such as a retainer or a sleeve to achieve additional functions of electrical conductivity, rigid spacing, or other functional characteristics as mentioned further herein.

More specifically, the applicant has invented a new elastomeric fastener which provides an assembly of panels without the use of threaded structures. The fastener includes a base of enlarged diameter and an elongate elastomeric shank extending from the base providing two states of dimension. The first is a relaxed state wherein the shank is substantially free of all external forces. The second state is tensile, wherein an axial tensile force applied to the shank stretches the shank into a condition of reduced diameter. In addition, there may be attachment means adjacent the base of the fastener securing it to a first panel.

A second panel has an aperture with a diameter greater than the second tensile state of the shank, but less than the diameter of the shank at the first relaxed state. During assembly, a bulge in the shank forceably contacting a backside of the second panel in the direction of the first panel is formed by first passing the shank through the aperture in the second panel while in the second tensile state, and then releasing the applied tensile force. The bulge provides a clamp force to the second panel so that the panels become secured together.

The fastener may further include an internal axial blind bore having an endwall proximate the distal end of a pin slidable within the bore and extending through to the outside of the opposite end of the fastener. Pushing the pin into the bore causes the longitudinal extension of the tail. This provides the above-described tail-stretching function and allows use of the fastener from one side of a panel only. Other aspects of the present invention will be more clearly shown from the following drawings and description of the preferred embodiment.

### BRIEF DESCRIPTION OF THE DRAWINGS

FIGS. 1-3 are a series of side partial sectional views showing, step-wise, the process of assembling panels utilizing the fastener of the invention.

FIG. 4 is a side partial sectional view showing an alternate embodiment of the invention.

FIGS. 5-7 are a series of side sectional views showing step-wise the application of the attachment of a panel to an alternate embodiment of the invention.

FIG. 8 is a side sectional view of an alternate embodiment of the invention.

FIG. 9 is a side sectional view of an alternate embodiment.

The preferred embodiments shown in the drawings depict fasteners which are substantially circular in lateral cross-section at all points along their length. Because they have axial symmetry, the side views shown in the above-described figures of drawing are sufficient to convey an understanding of the invention.

### DESCRIPTION OF THE PREFERRED EMBODIMENTS

Referring now to FIGS. 1-3, a simplistic embodiment of the invention is shown. The resilient standoff in these figures depicts a fastener with a head 13 that has an adhesive 15 applied to its end surface. Thus, no holes are required in panel 17 for assembly, thereby eliminating location tolerance requirements with the holes in either of the attached panels. The standoff can be assembled to panel 17 before or after it is attached to panel 11.

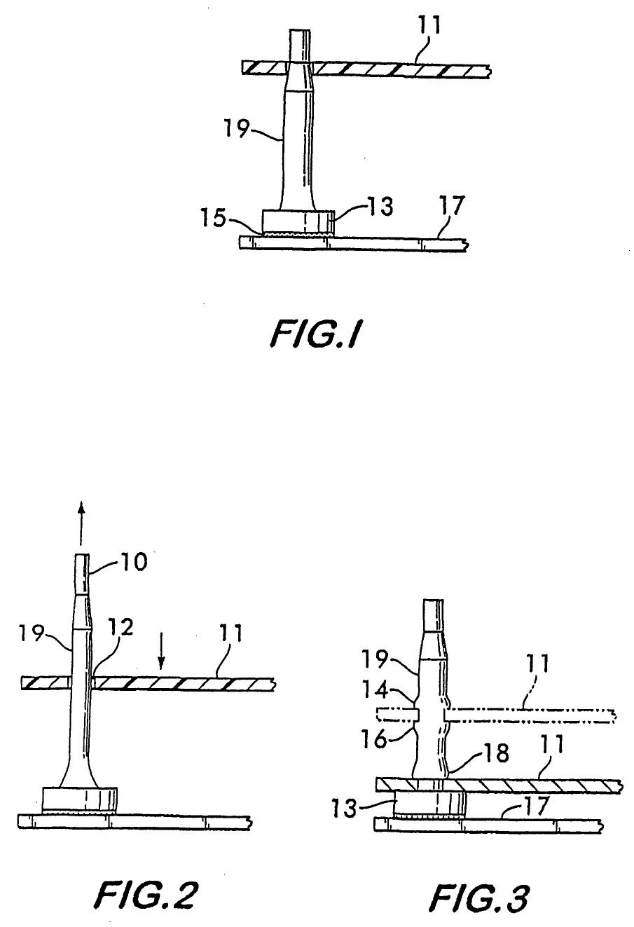

Assembly then proceeds as follows. First, the lead 10 is aligned and inserted into the hole 12 in panel 11. Once the tip of the tail 19 protrudes through the hole 12 in the panel 11, the tail can be stretched by manually pulling the lead 10. As the diameter of the tail 19 reduces to less than the diameter of the hole 12, the panel 11 will be able to slide freely over the tail 19 as shown in FIG. 2. If attached to panel 11 first, the first panel and fastener may be set onto panel 17 using the adhesive and the panels will be precisely located. The adhesive bond should be strong enough to withstand the repeated stretching force of the tail portion 19.

As shown in FIG. 3, once the desired position of the panel 11 is achieved, the tail 19 is relaxed and the diameter and length of the tail 19 will attempt to return to its original size, creating a gripping, bulged condition of the tail against the panel. The surface of the tail is preferably entirely smooth so that the gripped panel may be attached at any point along the length of the tail such as the location shown by the alternate location of panel 11 depicted in phantom lines. The result is bulges 14 and 16 formed on both sides of the panel 11 holding the panel firmly where it was located when the tail 19 was relaxed. The ability to vary the location of the attachment point along the tail may be utilized to achieve different spacing or degree of lateral resilience between the panels. To remove the panel 11, the tail 19 is stretched again thus eliminating the bulges 14 and 16 and allowing the panel to slide over the tail in either direction. If the tail is relaxed when the panel 11 is in the position depicted in solid lines, bulge 18 retains the panel against the base 13 which firmly determines the amount of space between the panels 11 and 17. This procedure described with regard to this form of the invention is applicable to the other embodiments which all function on the same elastomeric grip principle.

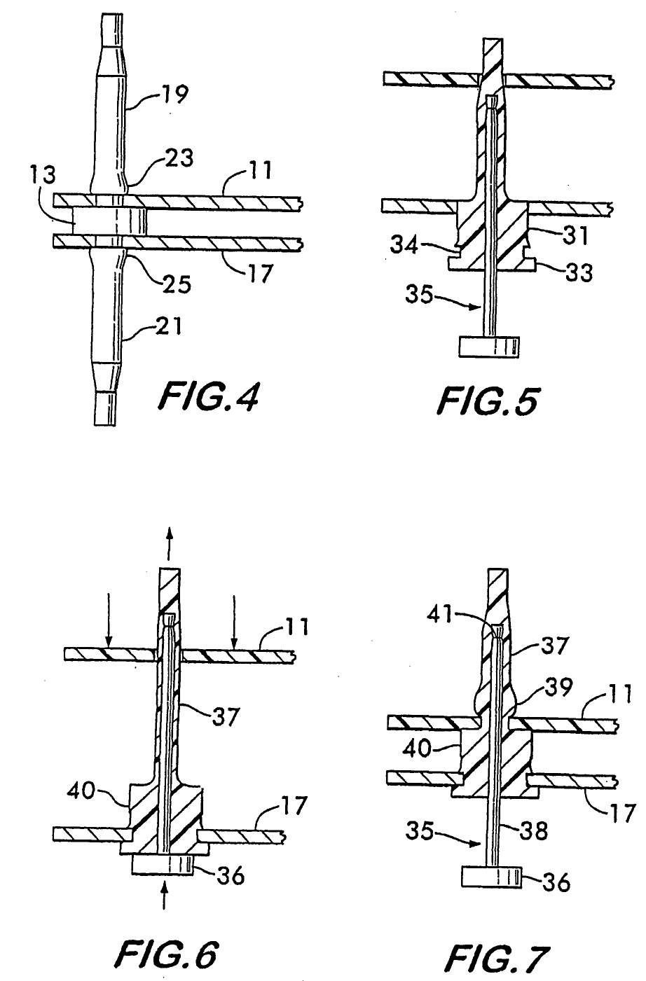

Refering now to FIG. 4, an additional embodiment is similar to the fastener shown in FIGS. 1-3, however another tail 21 has been added to the opposite side of the base 13. After following the procedures described regarding FIGS. 1-3 on one side, the procedure is repeated on the other side of the base 13 providing the positive separation of two panels 11 and 17 equal to the height of the base 13 held between them. With this panel placement, when the tails 19 and 21 are relaxed, two bulges 23 and 25 are formed holding the panels in place.

Referring now to FIG. 5, a more complex embodiment of the invention is depicted in which the base 31 of the fastener includes a head 33 and a push-pin actuator 35. The headed base of the fastener is first inserted through a hole in a first panel to which it is retained by groove 34 adjacent the underside of the head.

Referring to FIGS. 6 and 7, a second panel is then attached by the stretching and bulging of the elastomeric tail portion of the shank as described in the previous embodiments, however a push-pin provides means of stretching the fastener with access to only one side of the panel 17. The push-pin can be either molded-over by the resilient material or assembled in a later operation. The pin preferably has a shank 38, head 36, and the end of the pin may have a retention groove 41 that corresponds to a narrowed retention sleeve in the bore of the fastener to captivate the pin.

As shown in FIG. 6, pressing the head 36 of the push-pin at the base of the fastener stretches the tail 37 at the opposite end allowing the fitting-over of panel 11. When force against the push-pin 35 is relaxed as shown in FIG. 7, the bulge 39 retains and presses panel 11 against the annular underside of base 40. To remove the panel 11, the push-pin 35 is pressed again, eliminating the bulge 39 and allowing the panel 11 to slide back over the tail 37. In this embodiment, a barrel portion of the base 40 provides spacing means between the panels.

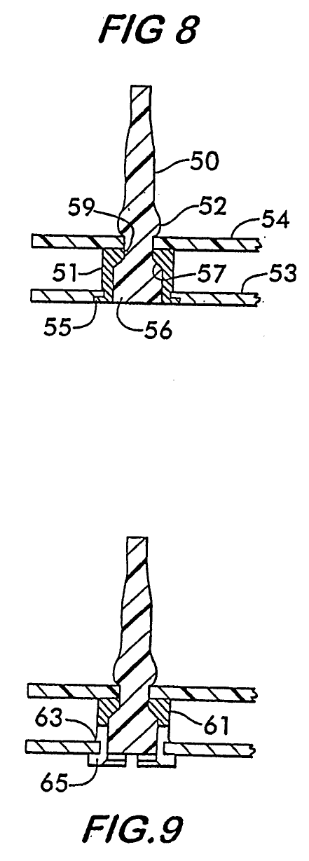

Referring now to FIG. 8, an alternate embodiment is shown in which electrical contact is provided between two spaced panels by using the resilient standoff in combination with a metal retainer 51. The metal retainer 51 may be permanently attached to a first ductile panel 53 by clinch means 55. In addition to the self-clinching feature 55, the retainer has a counterbore 57, and through-hole 59. The resilient portion of the standoff may be assembled either before or after the self-clinching retainer 51 is installed into ductile panel 53. It can attach itself to the retainer by gripping bulge 52 prior to assembly with panel 54 since the retainer through-hole, like the panel hole, is undersized with respect to the relaxed diameter of the tail 50. By assembling the panel as described above with regard to FIGS. 1-3, the panel 54 will make firm contact with the retainer 51, providing electrical contact between panels 53 and 54 if desired. Electrical conductivity can also be achieved by molding conductive material directly in the material of resilient standoff eliminating the need for the retainer. A simple metal sleeve or compression bushing inserted over the base 56 of the resilient standoff can also be used.

Referring now to FIG. 9, another insert configuration utilizes a snap-in retainer rather than the self-clinching retainer shown in FIG. 8. This retainer 61 can be temporarily inserted into any panel which therefore is not required to be ductile like the self-clinching embodiment of FIG. 8. The retainer 61 has a counterbore and a through-hole much the same as the retainer of FIG. 8 except that a snap protrusion 63 and a head 65 combine to provide snap-in attachment means which replaces the clinch feature. This embodiment can be employed to assembly panels much the same as described above with regard to the embodiment in FIG. 8.

In considering the above preferred embodiments, it will be realized that the many objectives and advantages of the invention have been achieved. The resilient standoff of the invention is not limited to use with any specific material. The resilient standoffs will not introduce metal chips or debris that can be damaging to electronics. There is no screw to accidentally drop onto sensitive equipment. No special tooling is required to assemble or disassemble the panels. The ease of assembly and disassembly reduces the time to repair an item by eliminating a loose screw. The fastener can be easily removed and re-assembled without damaging either the panels or the fastener. Also, the resilient material of the fastener can serve as an electrical insulator or conductor. Metal components can be over-molded or later assembled to the fastener in order to provide electrical contact or a ground. An adhesive can be added to part of the fastener thus eliminating the need to punch holes in one of the panels. The means by which this fastener retains components also makes this fastener resistant to loosening due to shock and vibration, unlike known plastic snap-in fasteners. Thus, it will be apparent that many of the problems in the prior art of panel fastening systems have been overcome.

It should be understood that there may be other modifications and changes to the present invention that will be obvious to those of skill in the art from the foregoing description, however, the present invention should be limited only by the following claims and their legal equivalents.

What is claimed is:

1. An assembly of panels secured by a non-threaded fastener composed of an elastomeric material, comprising:
an elastomeric fastener comprising:
a base of enlarged diameter at one end of a shank; and
an elongate elastomeric shank extending from said base, said shank providing two states of dimension: a first state being a relaxed state, wherein said shank is substantially free of all external forces and a second state of said shank being a tensile state, wherein an axial tensile force applied to said shank stretches the shank into a condition of reduced diameter;
attachment means on said fastener attaching a first panel thereto;
a second panel having an aperture with a diameter greater than said second tensile state of said shank, but less than the diameter of said shank at said first relaxed state, said shank passing through said aperture in said second panel; and
a bulge in said shank forceably contacting a backside of said second panel in the direction of said first panel, said bulge formable by first passing said shank through said aperture in said second panel while in said second tensile state, and then releasing said applied tensile force.

2. The assembly of panels of claim 1 further including spacing means, being an area of increased diameter of said shank greater than the diameter of said second aperture and located between said panels holding them a spaced distance apart.

3. An elastomeric fastener comprising:
a head of enlarged diameter at one end of an axially-extending shank, said head including an end surface;
attachment means adjacent said head for attaching said fastener to a panel; and
a longitudinally-extending elastomeric tail portion of said shank of reduced diameter providing two states of dimension: a first relaxed state, wherein said shank is substantially free of all external forces and a second tensile state of said shank, wherein an axial tensile force applied to said shank stretches the shank into a condition of reduced diameter.

4. The fastener of claim 3 further including a base portion of increased diameter integral with said shank, said base portion extending axially along said shank being located between the head of said fastener and said tail, and having a diameter less than the diameter of said head.

5. The fastener of claim 4 wherein said attachment means is a deformable circumferential groove adjacent said base of said head.

6. The fastener of claim 4 further including a retainer surrounding said base portion, said retainer including attachment means at one end thereof adjacent the end surface of said head.

7. The fastener of claim 6 wherein said retainer is metal.

8. The fastener of claim 7 wherein said attachment means is clinch means.

9. The fastener of claim 4 further including an internal axial blind bore having an endwall proximate the distal end of said shank, and a pin within said bore having a length greater than said bore, said pin extending through to an outside of said head whereby pushing said pin into said bore causes the longitudinal extension of said elastomeric tail.

10. The fastener of claim 2 wherein said spacing means is in abutment with said second panel.

11. The fastener of claim 5 being composed entirely of an elastomeric material.

12. An assembly of panels secured by a non-threaded fastener composed of an elastomeric material, comprising:
an elastomeric fastener comprising:
a head of enlarged diameter;
a base adjacent said head, said base being a portion of said shank of increased diameter less than the diameter of said head; and
an elongate shank extending from the base, said shank having an entirely smooth outer surface and providing two states of dimension: a first relaxed state, wherein said shank is substantially free of all external forces and a second state of said shank being a tensile state wherein an axial tensile force applied said shank stretches the shank to a condition of reduced diameter;
a first panel affixed to said head;
a second panel having an aperture with a diameter greater than said second tensile state of said shank, but less than the diameter of said shank at said first relaxed state, said shank passing through said aperture; and
a bulge in said shank forceably contacting a backside of said second panel in the direction of said first panel, said bulge formable by passing said shank through said aperture in said second panel while in its second tensile state and then releasing said tensile forces.

13. The fastener of claim 3 wherein said shank includes a distal end suitable for grasping to apply a tensile force thereto.

14. The fastener of claim 3 wherein said tail portion of said shank has an entirely smooth outer surface.

15. The fastener of claim 7 wherein said attachment means is rivet means.

16. The assembly of claim 1 further described in that said attachment means is an adhesive applied to the base.

17. The fastener of claim 7 wherein said retainer is metal and affixed to said base portion of said shank.

18. The assembly of claim 1 wherein said attachment means includes a retainer affixed to said base, said retainer being snap-fit into said first panel.

19. The assembly of claim 18 wherein said retainer is composed of metal.
